(19) United States
(12) Patent Application Publication
(10) Pub. No.: US 2011/0296347 A1
(43) Pub. Date: Dec. 1, 2011

(54) TEXT ENTRY TECHNIQUES

(75) Inventor: Dustin B. Andrews, Duval, WA (US)

(73) Assignee: Microsoft Corporation, Redmond, WA (US)

(21) Appl. No.: 12/787,717

(22) Filed: May 26, 2010

(51) Int. Cl. G06F 3/048; G06K 9/18

(52) U.S. Cl. 715/816; 382/182; 715/810

(57) ABSTRACT

Techniques for entering text are provided. In a particular implementation, a first input control is assigned to a particular group of text characters of a plurality of groups of text characters and a second input control is assigned to a particular text character based on user input. A user interface is displayed that includes the plurality of groups of text characters and indicates that the first input control corresponds to the particular group of text characters and that the second input control corresponds to the particular text character.

### BACKGROUND

Users of portable computing devices, such as mobile handsets and smart phones, often enter text in relation to creating text messages, picture messages, and video messages. Portable computing device users may also enter text during instant messaging sessions, Internet browsing sessions, and when composing emails.

Some text entry techniques, such as the Double Tap and Triple Tap techniques, utilize at least eight keys of a telephone keypad and the fixed set of text characters that are associated with each key, such as a-c being associated with the “2” key, d-f being associated with the “3” key, and so on. For example, to enter the letter “c” via the Double Tap technique, the “2” key may be pressed to select the letters a-c and the “3” key may be pressed to indicate selection of the letter “c.” To enter the letter “c” via the Triple Tap technique, a user would press the “2” key three times in succession without pausing. If a user pauses while attempting to enter “c” before pressing the “2” key three times, an “a” or a “b” may be entered unintentionally. Additionally, in some cases, a user must pause before entering a text character, such as when entering the same letter twice (e.g. “ee” or “oo”).

Another text entry technique, T9, involves selecting one or more keys that activate a predictive algorithm to supply a list of potential words based on the selected keys, where a particular word from the list may be chosen by an additional input. If the user is attempting to enter a word that the list of predicted words does not include, then the user may revert to using the Triple Tap technique. On-screen keyboards may also be utilized by portable computing device users to enter text. For example, arrow keys or another input device, such as a control stick, may be used to navigate to select text characters of the on-screen keyboard and a button of the portable computing device may be used to enter a selected text character.

Text entry via some smaller portable computing devices is often slower and less efficient than text entry via a laptop or desktop keyboard, such as a QWERTY keyboard, a DVORAK keyboard, or a foreign language keyboard. In some cases, since the number of keys available to enter text characters is less than the number of possible text characters that can be entered, text entry may be slow, error prone, and require a large number of key presses. In other cases, portable computing devices may include a small version of a QWERTY keyboard or another type of keyboard, but the small size of the keys tends to increase the amount of time needed to enter text and may lead to text entry errors.

### SUMMARY

This disclosure describes forming a plurality of groups from a number of text characters and dividing the text characters of each group into a plurality of sub-groups. At least one predetermined input control is assigned to each of the plurality of groups and at least one additional input control is dynamically assigned to a respective text character in response to selection of the input control assigned to the particular group.

Additionally, this disclosure describes assigning a first input control to a particular group of text characters of a plurality of groups of text characters and assigning a second input control to a particular text character based on user input. A user interface is then displayed that includes the plurality of groups of text characters and indicates that the first input control corresponds to the particular group of text characters and that the second input control corresponds to the particular text character.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE CONTENTS

The detailed description is described with reference to the accompanying Figures. In the Figures, the left-most digit(s) of a reference number identifies the Figure in which the reference number first appears. The use of the same reference numbers in different Figures indicates similar or identical items or features.

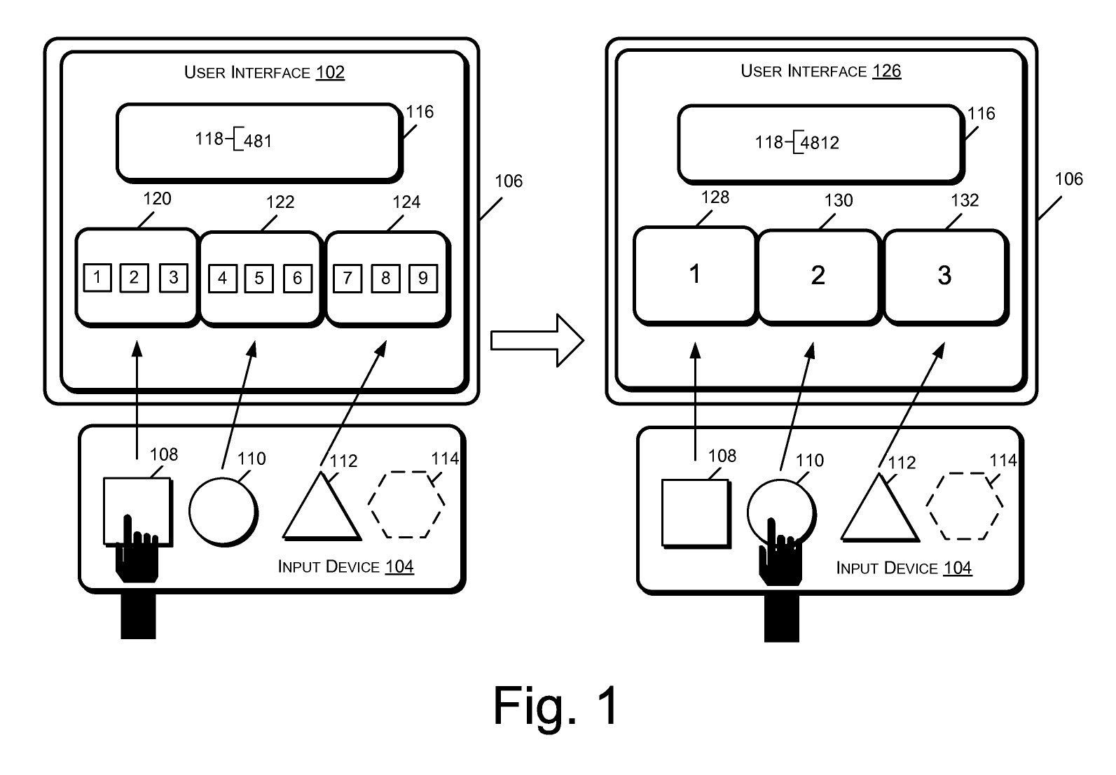

FIG. 1 illustrates entering text utilizing a user interface displaying text entry options and an input device to select from among the text entry options.

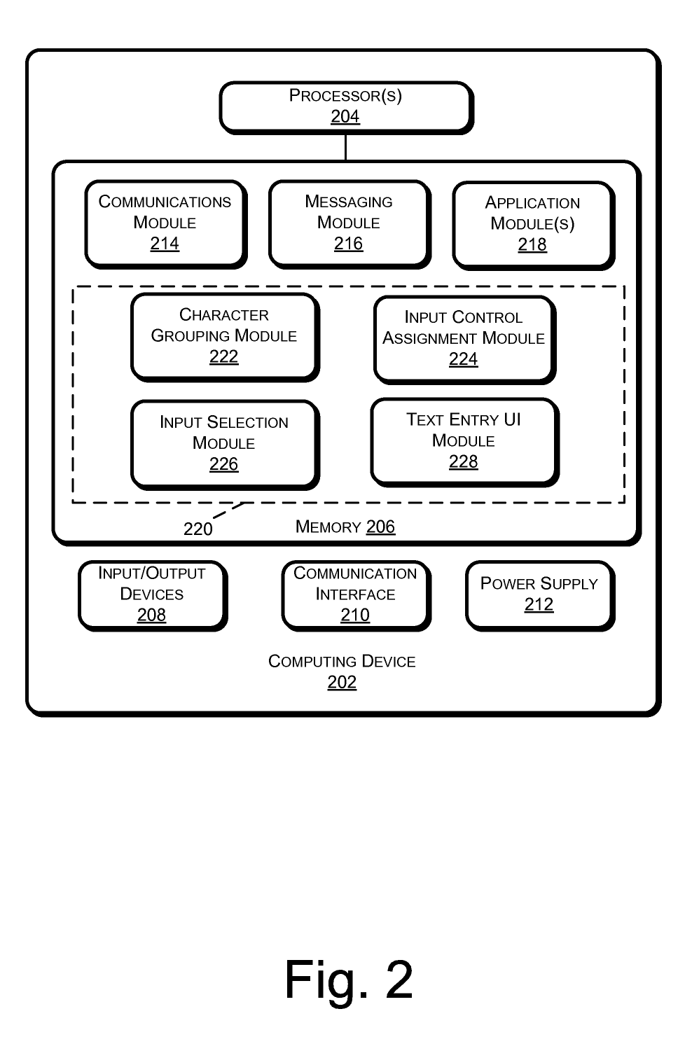

FIG. 2 illustrates a block diagram of a computing device implementing techniques to enter text.

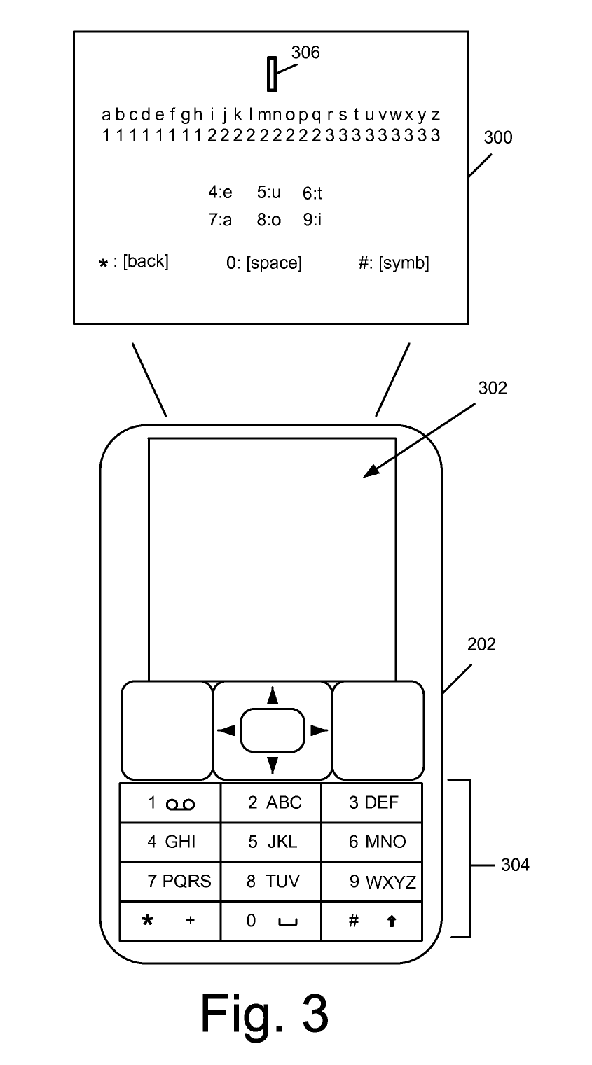

FIG. 3 illustrates a user interface to select a text character or select a group of text characters.

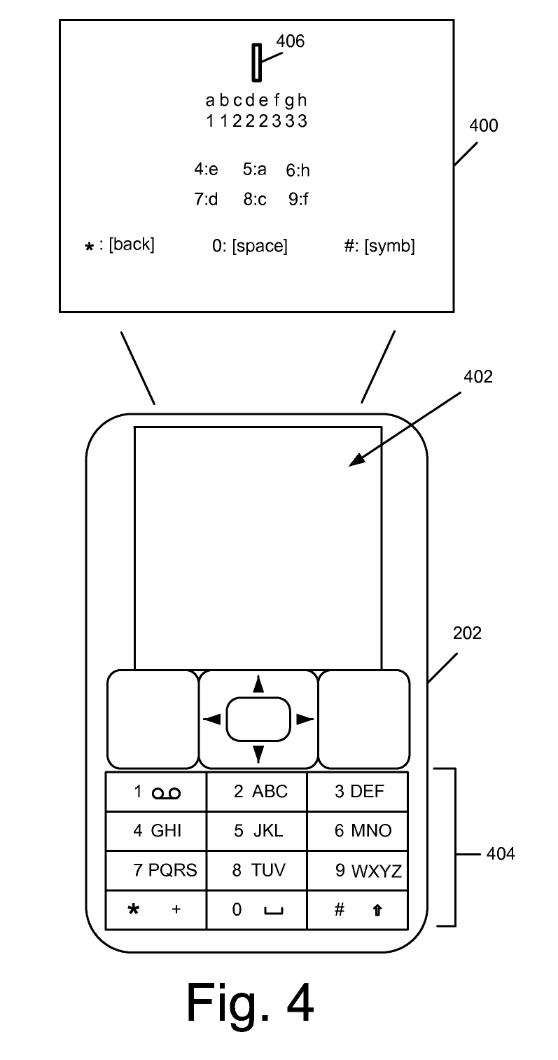

FIG. 4 illustrates a user interface to select a text character or select a sub-group of text characters in response to selection of a particular group of text characters.

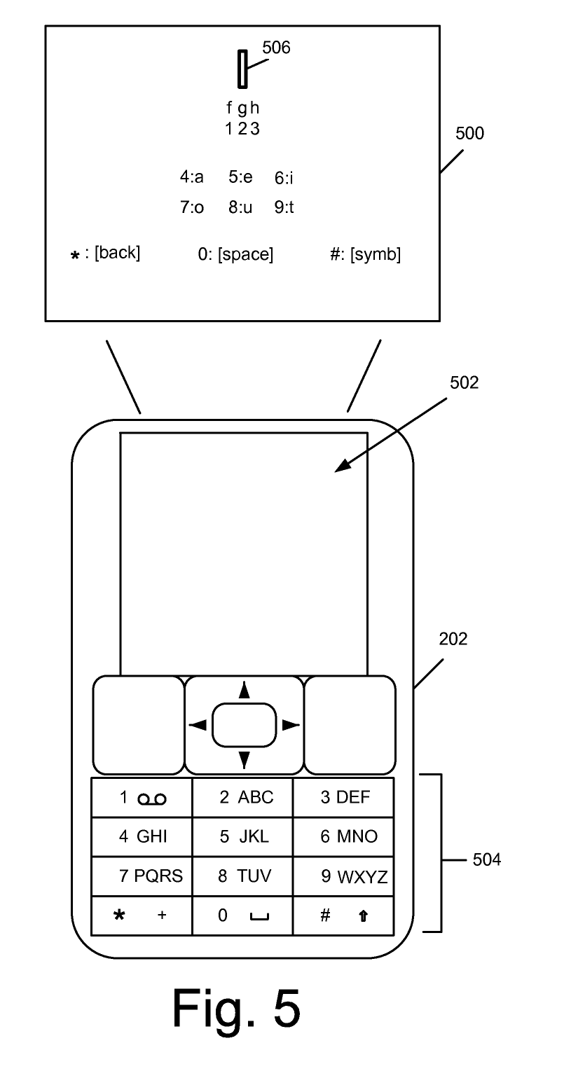

FIG. 5 illustrates a user interface to select a text character.

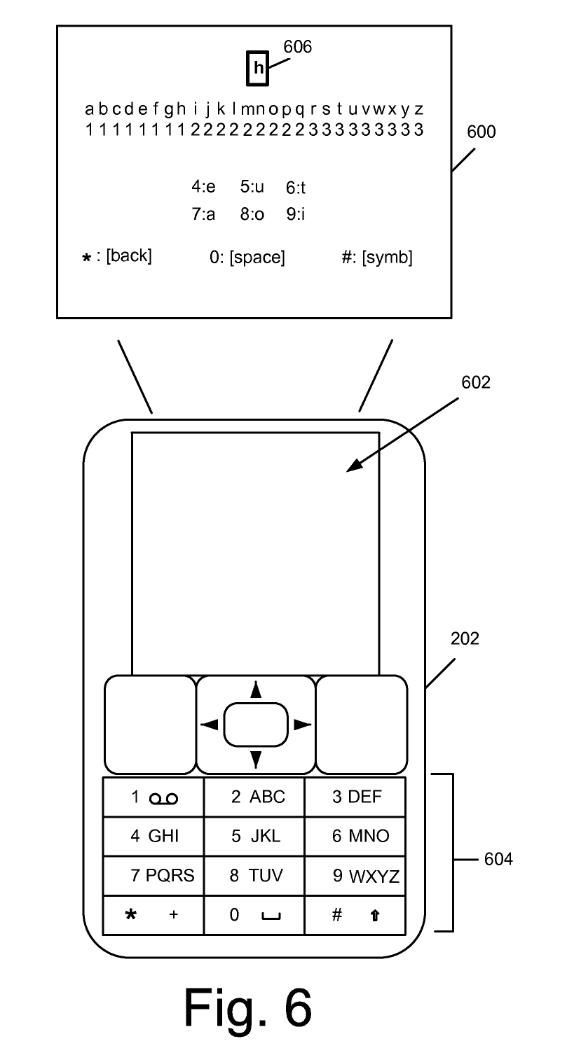

FIG. 6 illustrates a default user interface to select a text character or a group of text characters after selection of a text character.

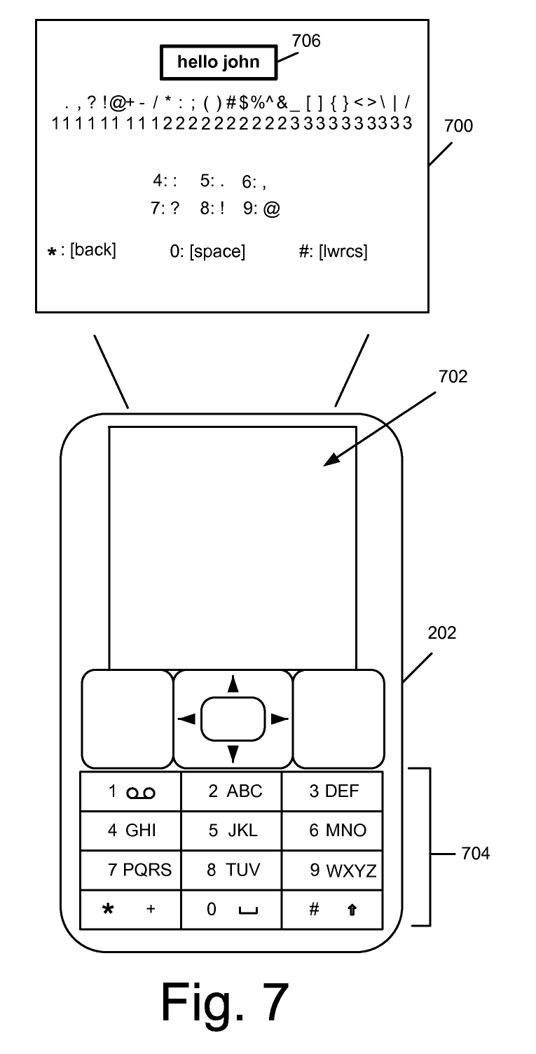

FIG. 7 illustrates a user interface to select a text character or a group of text characters from an additional set of text characters.

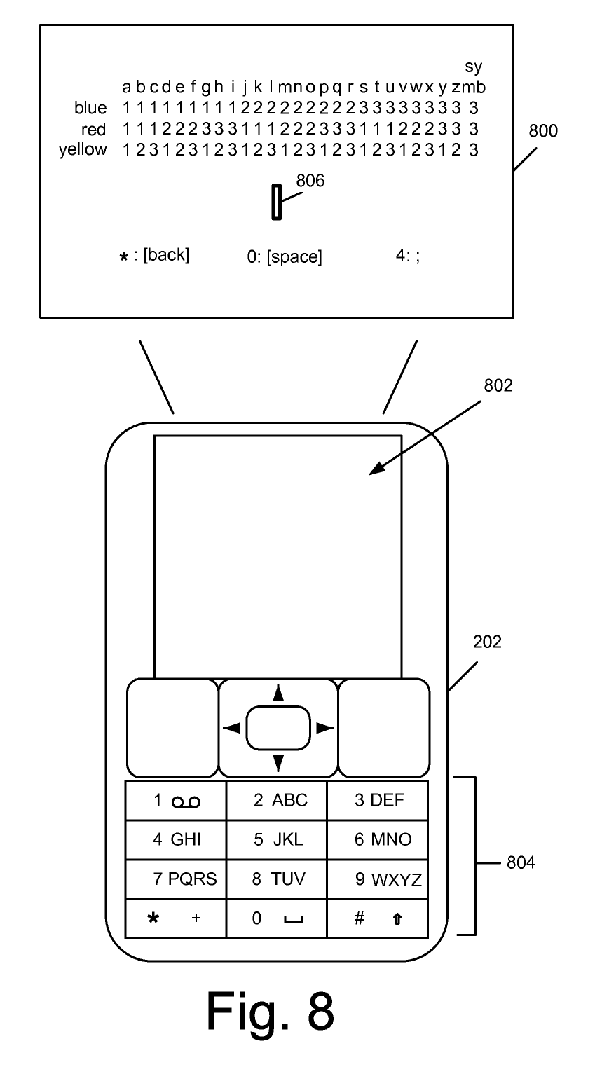

FIG. 8 illustrates a user interface indicating combinations of input controls to enter text characters.

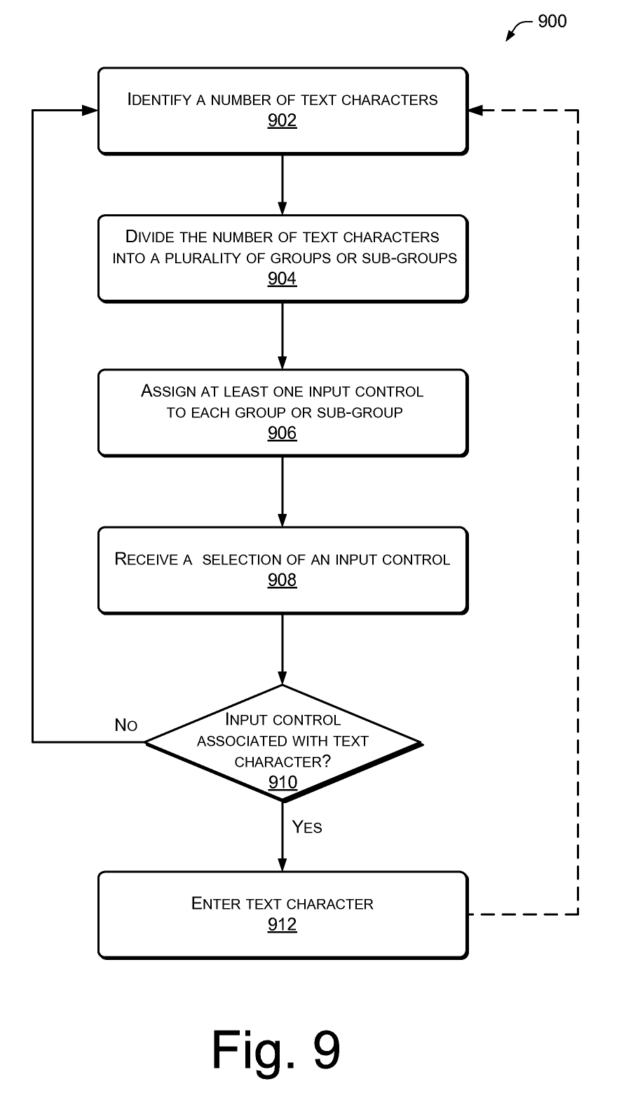

FIG. 9 is a flow diagram illustrating a first implementation of a process to enter text characters.

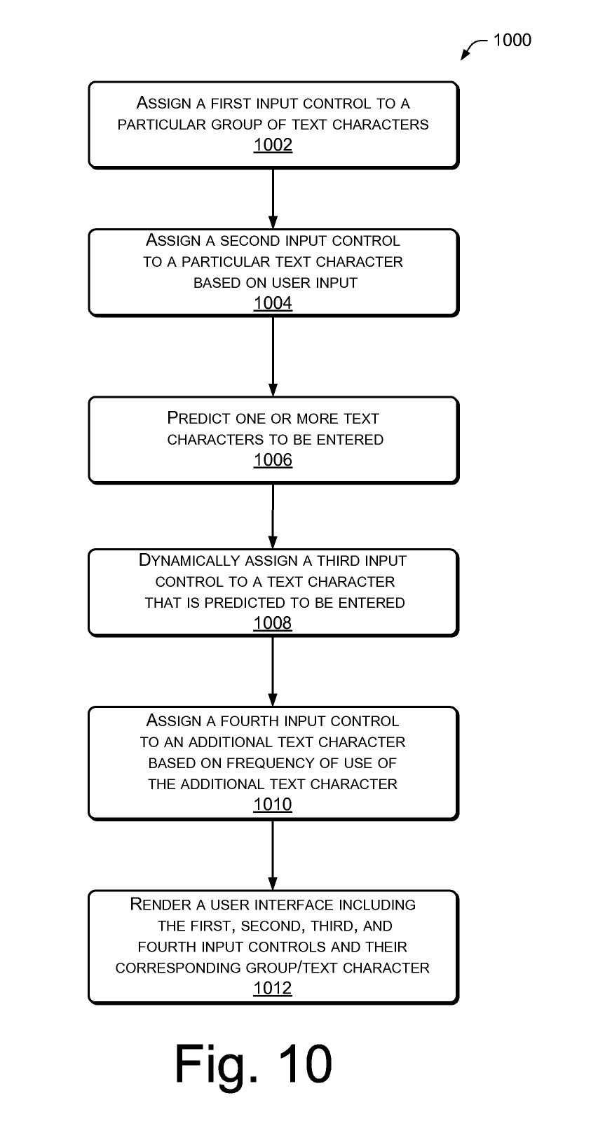

FIG. 10 is a flow diagram illustrating a second implementation of a process to enter text characters.

### DETAILED DESCRIPTION

FIG. 1 illustrates entering text utilizing a user interface 102 displaying text entry options and utilizing an input device 104 to select from among the text entry options. The user interface 102 may be provided via a display 106 of a portable computing device, such as a smart phone, a mobile handset, a personal digital assistant (PDA), a portable navigation device, a portable gaming device, a tablet computer, a watch, a portable media player, another portable computing device, and so on. The display 106 may also be a monitor, television, or other display device coupled to a particular computing device, such as a desktop computer or a gaming console.

The input device 104 may be integrated into a computing device. For example, the input device 104 may be a component of a smart phone or portable gaming device. Alternatively, the input device 104 may be implemented as a separate component of a computing system. In a particular example, the input device 104 may be a gaming controller or a remote control device coupled to a gaming console, a personal computer, or a media player.

The input device 104 includes a number of input controls 108-112. In some cases, the input device 104 may include one or more additional input controls 114. The input controls 108-114 may be physical input controls, such as buttons of a mobile handset keypad. In addition, the input controls 108-114 may be buttons or input devices of a gaming controller, such as bumper buttons, triggers, a directional pad, control sticks, or another type of gaming controller input device. The input controls 108-114 may also be implemented via a touch screen or virtual keypad.

The input controls 108-114 may be utilized to make selections of items shown in the user interface 102. In some cases, the input controls 108-114 may be used to enter text characters to compose a message of a messaging application, such as a text messaging application, an instant messaging application, a picture messaging application, or a video messaging application. The input controls 108-114 may also be used to enter text characters in a word processing application, a browser application, a spreadsheet application, an email application, or a combination thereof.

In an illustrative implementation, the user interface 102 includes a text entry portion 116 for entering text characters 118. In addition, the user interface 102 includes text entry options 120, 122, and 124 that may be selected via a particular input control 108-112. In the example shown in FIG. 1, the first text entry option 120 of the user interface 102 is associated with text characters 1-3, the second text entry option 122 is associated with text characters 4-6, and the third text entry option 124 of the user interface 102 is associated with text characters 7-9. Although the text characters of the text entry options 120-124 are shown as numbers 1-9, the text characters associated with the text entry options 120-124 may be numbers, letters, symbols, or a combination thereof. In addition, although the numbers 1-9 are shown as individual text characters, the numbers 1-9 may represent groups of text characters.

Additionally, in the illustrative example of FIG. 1, the input control 108 is associated with the first text entry option 120, the input control 110 is associated with the second text entry option 122, and the input control 112 is associated with the third text entry option 124. Thus, selection of a particular input control 108-112 results in selection of the group of text characters corresponding to a respective text entry option 120-124. For example, selection of the input control 108 would specify selection of the characters 1-3 of the first text entry option 120.

Although the input control 114 is not associated with any particular group of text characters in FIG. 1, the input control 114 may be activated to specify selection of a particular character. For example, the input control 114 may be associated with a character that is most frequently used, such as the text character 3. In another example, a user of the input device 104 may specify that the input control 114 is associated with a particular text character, such as the text character 5, or a particular group of text characters. In this way, a user can customize the input controls associated with certain text characters, such as a user's favorite text character or favorite group of text characters. In a further example, the input control 114 may be used to display different sets of text characters. To illustrate, selection of the input control 114 may change the characters displayed in each text entry option 120-124. For example, characters 10-12 may be displayed in the first text entry option, characters 13-15 may be displayed in the second text entry option 122, and characters 16-18 may be displayed in the third text entry option 124 in response to selection of the input control 114.

After selection of an input control 120-124, an additional user interface 126 may be rendered on the display 106. The additional user interface 126 also includes the text entry portion 116 and text characters entered 118. Further, the additional user interface 126 includes text entry options 128-132. The text entry options 128-132 correspond to respective characters or groups of characters associated with the selected text entry option 120-124 of the user interface 102. For example, upon selection of the text entry option 120 of the user interface 102, each of the characters 1-3 may be associated with a particular text entry option 128-132 of the additional user interface 126. In particular, the character 1 is associated with the first text entry option 128, the character 2 is associated with the second text entry option 130, and the character 3 is associated with the third text entry option 132. Each text entry option 128-132 is in turn associated with one of the input controls 108-112. In the illustrative example shown in FIG. 1, the first input control 108 is associated with the first text entry option 128, the second input control 110 is associated with the second text entry option 130, and the third input control 112 is associated with the third text entry option 132. In addition, as shown in FIG. 1, upon selection of the second text entry option 130 via the input control 110, the text character 2 is entered in the text entry portion 116.

By dividing groups of text characters into sub-groups and progressively narrowing the number of possible text characters to enter via selection of input controls, the number of input controls utilized to select text characters can be reduced. When the number of input controls to enter text characters is reduced, any additional input controls can be customized to fit the particular habits or preferences of a user. Additionally, the total number of input control selections made to compose a message may be reduced and text characters can be entered without pausing. Thus, the speed of text entry may be increased and the number of errors reduced.

FIG. 2 illustrates a block diagram of a computing device 202 implementing techniques to enter text. The computing device 202 may be a server computer, a personal computer, a desktop computer, a laptop computer, a tablet computer, a portable navigation system, a personal digital assistant (PDA), a portable media player, an entertainment device, a netbook, a gaming console, an electronic book reader device, a smart phone, a mobile handset, a DVD player, a media center, a household appliance, a watch, another suitable computing device, or the like. The computing device 202 includes one or more processors 204 and memory 206. The memory 206 is an example of computer-readable storage media and may include volatile memory, nonvolatile memory, removable memory, non-removable memory, or a combination thereof. For example, the memory 206 may include, but is not limited to, RAM, ROM, EEPROM, flash memory, one or more hard disks, solid state drives, floppy disks, optical memory (e.g., CD, DVD), or other non-transient memory technologies.

The computing device 202 also includes input/output devices 208. The input/output devices 208 may include a QWERTY keyboard, a DVORAK keyboard, a foreign language keyboard, another type of keyboard, a telephone keypad, a pointer device, a touch pad, a bumper button, a trigger, a directional pad, a control stick, a touch screen, a trackball, a gaming controller, a display device, one or more speakers, a microphone, a camera, and one or more other input/output devices. In some cases, the input/output devices 208 may be separate from the computing device 208, such as a gaming controller or monitor coupled to the computing device 202. In addition, the computing device 202 includes one or more communication interfaces 210 to facilitate wired and/or wireless communications via a wired and/or wireless network, such as the Internet, cable networks, satellite networks, wide area wireless communication networks, wireless local area networks, and public switched telephone networks (PSTN). In a particular implementation, the communication interface 210 includes a wireline and/or wireless interface to exchange data with a gaming controller or other input device separate from the computing device 202. The communication interface 210 may also include a wired and/or wireless interface to communicate with a display device separate from the computing device 202. The computing device 202 also includes a power supply 212, such as a battery.

The memory 206 includes a communications module 214 executable by the processor 204 to exchange communications with other computing devices. For example, the communications module 214 may transmit and receive voice communications, such as telephone calls. In addition, the communications module 214 may retrieve data via the Internet, such as content of web sites, the downloading of data to the computing device 202 (e.g. media files), the transmitting and receiving of messages (e.g. email and text messages), and so on.

The memory 206 also includes a messaging module 216 executable by the processor to create text, picture, and/or video messages, to participate in instant messaging sessions, or a combination thereof. Additionally, the memory 206 includes one or more application modules 218. The one or more application modules 218 may include a browser application, a word processing application, a spreadsheet application, an email application, an operating system, one or more gaming applications, a GPS application, a media playback application, and so on.

Further, the memory 206 includes a text entry module 220 that is executable by the processor 204 to enter text for one or more of the application modules 218, the messaging module 216, or a combination thereof. In some cases, the text entry module 220 may be called upon execution of the messaging module 216 or one of the application modules 218.

The text entry module 220 includes a character grouping module 222. The character grouping module 222 is executable by the processor to divide a number of text characters into a plurality of groups. For example, the character grouping module 222 may divide text characters of an alphabet into a plurality of groups. In a particular implementation, the character grouping module 222 may group the English alphabet containing 26 characters into 3 groups. A first group including the letters a-h, a second group including the letters i-q, and a third group including the letters r-z. The character grouping module 222 may also group different forms of text characters, such as grouping lowercase and uppercase text characters of an alphabet. The character grouping module 222 may also divide other text characters, such as punctuation symbols, into a plurality of groups.

In addition to dividing text characters into groups, the character grouping module 222 may further divide each group of text characters into a plurality of sub-groups and also divide each sub-group into a plurality of additional sub-groups. For example, a group including the letters a-h may be divided into three sub-groups, with a first sub-group including the letters a-b, the second sub-group including the letters c-e, and the third sub-group including the letters f-h. Further, the sub-group including the letters c-e may be divided into additional sub-groups including the individual letters c, d, and e.

The text entry module 220 also includes an input control assignment module 224. The input control assignment module 224 may be executable by the processor 204 to assign one or more input controls, such as buttons of a keypad, to a group or sub-group of text characters. Continuing with the English alphabet grouping example from above, the input control assignment module 224 may assign the keypad button “1” of a mobile handset to the group including the letters a-h, assign the keypad button “2” to the group including the letters i-q, and assign the keypad button “3” to the group including the letters r-z. In some cases, multiple input controls, such as an entire row or column of keypad buttons, may be assigned to a particular group. For example, the group including the letters a-h may be assigned to the keypad buttons 1, 4, and 7 or the keypad buttons 1, 2, and 3.

Additionally, the input control assignment module 224 may assign input controls to the sub-groups associated with each group. To illustrate, the input control assignment module 224 may assign the keypad button “1” to the sub-group a-b, the keypad button “2” to the sub-group c-e, and the keypad button “3” to the sub-group f-h. The input control assignment module 224 may also assign input controls to each individual text character of each sub-group. For example, with respect to the c-e sub-group, the input control assignment module 224 may assign the keypad button “1” to the letter “c,” the keypad button “2” to the letter “d,” and the keypad button “3” to the letter “e.”

In some implementations, the input control assignment module 224 assigns input controls to groups of text characters, sub-groups of text characters, and/or the individual text characters of each sub-group before execution of the text entry module 220. For example, the input control assignment module 224 may assign particular combinations of input controls to enter corresponding text characters. In a particular scenario, selecting the combination of keypad buttons “123” may correspond to the letter “f,” while selecting the combination of keypad buttons “222” may correspond to the letter “n.” In other implementations, the input control assignment module 224 assigns input controls to groups of text characters, sub-groups of text characters, and/or the individual text characters of each sub-group dynamically as text is being entered during execution of a particular application.

In some cases, the input control assignment module 224 may assign input controls to individual text characters in addition to assigning input controls to groups and sub-groups of text characters. In particular, the input control assignment module 224 may assign an additional input control to a particular text character based on user input. For example, a user of the computing device 202 may assign an additional input control, such as the keypad button “4,” to the letter “t” and an additional input control, such as the keypad button “5,” to the letter “r” because “t” and “r” are frequently entered by the user. In another example, the input control assignment module 224 may track the frequency of use of each text character and automatically assign one or more input controls to particular text characters based on the text characters most frequently entered by the user of the computing device 202.

Additionally, the input control assignment module 224 may predict one or more text characters to be entered by a user of the computing device 202. In a particular implementation, based on user history of text character entry, previous characters that have been entered for a current message, and/or other criteria, the input control assignment module 224 may predict that one or more text characters are likely to follow the last character entered in the current message and assign one or more additional input controls to the predicted text characters. For example, after entering the string “th,” the input control assignment module 224 may assign respective input controls, such as the keypad buttons “7,” “8,” and “9,” to the possible next text characters to be entered, such as “e,” “a,” and “i” depending on the number of additional input controls available for assignment. In addition, the input control assignment module 224 may assign an additional input control to a group of predicted text characters. Continuing with the above example, upon entry of the string “th,” the input control assignment module 224 may assign an additional input control to the text characters “is,” an additional input control to the text characters “at,” and/or assign additional input controls to the words “this” and “that” as the most likely text characters or words to be entered next.

In some cases, the text characters assigned to the additional input controls may change based on the text characters previously entered. For example, if the letter “i” is entered after the string “th,” the input control assignment module 224 may assign the keypad button “4” to the letter “s” and the keypad button “5” to the letters “nk” and/or assign the keypad button “6” to the word “think.” The input control assignment module 224 may also assign some input controls to fixed text characters or to certain operations. For example, the keypad button “*” may regularly be associated with the backspace operation and the keypad button “5” may regularly be assigned to the text character “a.”

The text entry module 220 includes an input selection module 226 that is executable by the processor 204 to receive indications that an input control has been activated. For example, the input selection module 226 may receive an indication that a button of a keypad has been pressed, that a particular portion of a touch screen has been touched, that a particular movement of a control stick has been made, that a particular button of a gaming controller has been pressed, etc. The indication received by the input selection module 226 may relate to selection of a particular text character, selection of a group of text characters, or selection of an additional set of text characters.

Further, the text entry module 220 includes a text entry user interface (UI) module 228 executable by the processor 204 to render user interfaces related to the entry of text characters. In some implementations, the text entry UI module 228 may render a user interface indicating a number of groups of text characters and respective input controls that are associated with the groups of text characters. The text entry UI module 228 may also render a user interface indicating respective input controls associated with individual text characters and/or text entry operations. In particular, the text entry UI module 228 may render a user interface indicating an input control associated with a particular text character based on input from a user of the computing device 202. Additionally, the text entry UI module 228 may render a user interface indicating an input control associated with one or more predicted text characters based on previously entered text characters. Examples of user interfaces rendered via the text entry UI module 228 are shown in FIGS. 3-8.

In an illustrative implementation, the text entry UI module 228 may render a user interface including a default assignment of input controls to groups of text characters, to individual text characters, to text entry operations, or a combination thereof. The text entry UI module 228 may render a user interface including the default assignment of input controls at the beginning of text entry for a particular application, such as in response to activation of the messaging module 216 to enter a text message. In addition, the text entry UI module 228 may render a user interface including the default assignment of input controls upon entry of a text character.

Upon selection of a group of text characters from a user interface including a default assignment of input controls to a plurality of groups of text characters, the text entry UI module 228 may render an additional user interface including sub-groups formed from the selected group of text characters and the particular input controls associated with each of the sub-groups. Further, the additional user interface may include individual text characters and/or text entry operations and the respective input controls associated with the individual text characters and/or text entry operations.

In some cases, the individual text characters and text entry operations of the additional user interface are the same as the individual text entry characters and text entry operations of the default assignment of input controls. In other cases, the individual text characters and text entry operations of the additional user interface are different from those of the default assignment of input controls. For example, a user of the computing device 202 may specify that upon selection of a particular group or text character that the text entry UI module 228 renders a user interface indicating that particular text characters are associated with particular input controls. To illustrate, a user of the computing device 202 may specify that upon entry of a consonant that the vowels a, e, i, o, and u are included in a user interface with a respective input control corresponding to each vowel.

Additionally, upon selection of a particular group of text characters, the text entry UI module 228 may render a user interface including one or more predicted text characters based on the group selected, based on previously entered text characters, or a combination thereof. In an illustrative example, upon selection of a particular group of text characters, the input control assignment module 224 may determine one or more text characters that are likely to be entered next and dynamically assign an input control to those text characters. The text entry UI module 228 then renders a user interface including the selected group of text characters divided into sub-groups, the input controls assigned to each sub-group, the predicted text characters, and the input controls corresponding to the predicted text characters.

FIG. 3 illustrates a computing device 202 having a user interface 300 that is utilized to select a text character or select a group of text characters. The computing device 202 includes a display 302 and a keypad 304. The user interface 300 is shown on the display 302. The keypad 304 includes a number of buttons, also referred to herein as examples of “input controls,” such as the numbers 0-9 and the symbols “*” and “#.”

The user interface 300 includes a text entry portion 306 that shows text characters that have been entered. The user interface 300 also indicates a plurality of groups of text characters and the input controls associated with each group. For example, the user interface 300 indicates that the group of text characters a-h is associated with the input control “1” of the keypad 304, that the text characters i-q are associated with the input control “2” of the keypad 304, and that the text characters r-z are associated with the input control “3” of the keypad 304.

The user interface 300 also indicates that a number of individual text characters are associated with a respective input control. For example, the user interface 300 indicates that the text character “e” is associated with the input control “4,” that the text character “u” is associated with the input control “5,” and that the text character “t” is associated with the input control “6.” In addition, the user interface 300 indicates that the text character “a” is associated with the input control “7,” that the text character “o” is associated with the input control “8,” and that the text character “i” is associated with the input control “9.” Although the text characters associated with the input controls 4-9 are included in the groups of text characters shown in the user interface 300, at least some of the text characters associated with the input controls 4-9 may be associated with a different set of characters. For example, the input control “4” may be associated with a punctuation symbol (e.g. “:”).

Further, certain input controls shown in the user interface 300 are associated with respective text entry operations. To illustrate, the input control “*” is associated with the “backspace” text entry operation, the input control “0” is associated with the text entry operation “space,” and the input control “#” is associated with changing to a user interface including a set of text characters different from those of the user interface 300, such as uppercase letters, punctuation symbols, or text characters of another alphabet. In addition, the input control “#” may be associated with a different portion of the set of characters comprising the groups shown in the user interface 300. For example, when a set of text characters includes a large number of text characters, the set of text characters may be divided among a plurality of pages and the input control “#” may be selected to show the additional pages including the remaining text characters.

The respective input control associated with a particular text character may be based on user input, on frequency of use of the particular text character, and/or based on a prediction that the particular text character is to be entered. For example, the text characters “a,” “e,” “i,” “o,” : and “u” may be associated with an input control in the user interface 300 because those text characters are frequently used and the text character “t” may be associated with an input control based on user input customizing the text character associated with the input control “6.” In some cases, the text characters and input controls associated with each respective text character included in the user interface 300 may comprise a default arrangement of an initial user interface that is presented each time a text character is to be entered.

FIG. 4 illustrates a user interface 400 to select a text character or select a sub-group of text characters in response to selection of a particular group of text characters. The user interface 400 may be rendered via a computing device 202. The computing device 202 includes a display 402 and keypad 404. The keypad 404 includes a number of keys, such as the numbers 0-9 and the symbols “*” and “#,” which may also be referred to herein as “input controls.” The user interface 400 includes a text entry portion 406 that shows text characters that have been entered.

The user interface 400 may represent a continuation of a process of selecting a text character that started with the user interface 300 of FIG. 3. For example, the user interface 400 may include the text characters of the group of text characters a-h of the user interface 300 in response to selection of the input control “1” during the rendering of the user interface 300. The text characters of the group a-h have been divided into sub-groups in the user interface 400. In particular, the group a-h may include a first sub-group having text characters a-b, a second sub-group having text characters c-e, and a third sub-group having text characters f-h. Each of the sub-groups of the user interface 400 may be associated with a respective input control. As shown in FIG. 4, the sub-group a-b is associated with the input control “1,” the sub-group c-e is associated with the input control “2,” and the sub-group f-h is associated with the input control “3.”

Additionally, some input controls may be associated with individual text characters. In some cases, the individual text characters and the input controls corresponding to each text character may be the same as those of a default arrangement. In other situations, the individual text characters and the input controls corresponding to each text character may change based on a group that was previously selected. In the particular example of FIG. 4, the input controls are associated with text characters from the sub-group included in the user interface 400. For example, the input control “4” is associated with the text character “e,” the input control “5” is associated with the text character “a,” the input control “6” is associated with the text character “h,” the input control “7” is associated with the text character “d,” the input control “8” is associated with the text character “c,” and the input control “9” is associated with the text character “f” The individual text characters associated with respective additional input controls may be based on frequency of use of the text characters, user input, or a combination thereof.

Further, certain input controls of the user interface 400 are associated with respective text entry operations. In some scenarios, the text entry operations and the corresponding input controls may be the same as those in default arrangement shown in the user interface 300. In other situations, the text entry operations and the corresponding input controls may be different from those in the user interface 300. In the user interface 400, the input control “*” is associated with the “backspace” text entry operation, the input control “0” is associated with the text entry operation “space,” and the input control “#” is associated with changing to a user interface including a set of text characters different from those of the user interface 400.

FIG. 5 illustrates a user interface 500 to select a text character. The user interface 500 may be rendered via a computing device 202. The computing device 202 includes a display 502 and keypad 504. The keypad 504 includes a number of keys, such as the numbers 0-9 and the symbols “*” and “#,” which may also be referred to herein as “input controls.” The user interface 500 includes a text entry portion 506 that shows text characters that have been entered.

The user interface 500 may represent a continuation of the process of selecting a text character that started with the user interface 300 of FIG. 3 and continued with the user interface 400 of FIG. 4. For example, the user interface 500 may include the text characters of the group of text characters f-h of the user interface 400 in response to selection of the input control “3” while rendering the user interface 400. The text characters of the group f-h have been divided into additional sub-groups in the user interface 500. In particular, the sub-group f-h may be divided into individual text characters and each of the individual text characters may be associated with a respective input control. As shown in FIG. 5, the text character “f” is associated with the input control “1,” the text character “g” is associated with the input control “2,” and the text character h is associated with the input control “3.”

Further, some input controls may be associated with additional individual text characters. In some cases, the additional individual text characters and the input controls corresponding to each text character may be the same as those of a default arrangement. In other scenarios, the individual text characters and the input controls corresponding to each text character may change based on a sub-group that was previously selected. In the particular example of FIG. 5, the input control “4” is associated with the text character “a,” the input control “5” is associated with the text character “e,” the input control “6” is associated with the text character “i,” the input control “7” is associated with the text character “o,” the input control “8” is associated with the text character “u,” and the input control “9” is associated with the text character “t.” The additional individual text characters associated with respective additional input controls may be based on frequency of use of the text characters, user input, or a combination thereof.

In addition, certain input controls of the user interface 500 are associated with respective text entry operations. In some cases, the text entry operations and the corresponding input controls may be the same as those in the user interface 300 and the user interface 400. In other situations, the text entry operations and the corresponding input controls may be different from those in the user interface 300 or the user interface 400. In the user interface 500, the input control “*” is associated with the “backspace” text entry operation, the input control “0” is associated with the text entry operation “space,” and the input control “#” is associated with changing to a user interface including a set of text characters different from those of the user interface 500.

FIG. 6 illustrates a user interface 600 to select a text character or a group of text characters after selection of a text character. The user interface 600 may be rendered via a computing device 202. The computing device 202 includes a display 602 and keypad 604. The keypad 604 includes a number of keys, such as the numbers 0-9 and the symbols “*” and “#,” which may also be referred to herein as “input controls.”

The user interface 600 includes a text entry portion 606 indicating that the letter “h” has been selected by a user of the computing device 202. The letter “h” may have been selected via activation of a particular input control. In one example, the letter “h” may have been selected upon activation of the input control “6” during rendering of the user interface 400. In another example, the letter “h” may have been selected upon activation of the input control “3” during rendering of the user interface 500.

In addition to showing selection of the letter “h” in the text entry portion 606, the user interface 600 may also indicate a number of groups of text characters and an input control associated with each group. In particular, the user interface 600 includes the groups of text characters and corresponding input controls of the user interface 300. Further, the user interface 600 may include individual text characters and the respective input controls associated with each individual text character. For example, the user interface 600 includes the individual text characters and the input controls corresponding to each individual text character of the user interface 300. In addition, certain input controls of the user interface 600 are associated with respective text entry operations, such as the text entry operations and corresponding input controls of the user interface 300.

FIG. 7 illustrates a user interface 700 to select a text character or a group of text characters from an additional set of text characters. The user interface 700 may be rendered via a computing device 202. The computing device 202 includes a display 702 and keypad 704. The keypad 704 includes a number of keys, such as the numbers 0-9 and the symbols “*” and “#,” which may also be referred to herein as “input controls.”

The user interface 700 includes a text entry portion 706 that shows a portion of a message entered via the computing device 202. In particular, the text entry portion 706 includes the message portion, “hello john.” The user interface 700 also indicates a plurality of groups of text characters included in an additional set of text characters. In particular, the user interface 700 includes groups of text characters included in a set of twenty-nine punctuation symbols. Each group of punctuation symbols is associated with a particular input control. For example, the input control “1” is associated with a first group of nine punctuation symbols, the input control “2” is associated with a second group of ten punctuation symbols, and the input control “3” is associated with a third group of ten punctuation symbols. Each group of punctuation symbols may be selected via activation of the corresponding input control. In response to selection of a particular group of punctuation symbols, the selected group may be divided into sub-groups, and possibly divided further into individual punctuation symbols in a manner similar to the process described with respect to the English alphabet text characters of FIGS. 3-6.

The user interface 700 also indicates that a number of individual punctuation symbols are associated with a respective input control. For example, the user interface 700 indicates that the punctuation symbol “:” is associated with the input control “4,” that the punctuation symbol “.” is associated with the input control “5,” and that the punctuation symbol “,” is associated with the input control “6.” In addition, the user interface 700 indicates that the punctuation symbol “?” is associated with the input control “7,” that the punctuation symbol “!” is associated with the input control “8,” and that the punctuation symbol “@” is associated with the input control “9.” The respective input control associated with a particular punctuation symbol may be based on user input, on frequency of use of the particular punctuation symbol, and/or based on a prediction that the particular punctuation symbol is to be entered next.

Further, certain input controls of the user interface 700 are associated with respective text entry operations. To illustrate, the input control “*” is associated with the “backspace” text entry operation, the input control “0” is associated with the text entry operation “space,” and the input control “#” is associated with changing to a user interface including a set of text characters including lowercase English alphabet text characters.

FIG. 8 illustrates a user interface 800 indicating a combination of input controls to enter particular text characters. The user interface 800 may be rendered via a computing device 202. The computing device 202 includes a display 802 and keypad 804. The keypad 804 includes a number of keys, such as the numbers 0-9 and the symbols “*” and “#,” which may also be referred to herein as “input controls.”

The user interface 800 includes a text entry portion 806 that shows text characters that have been entered. The user interface 800 also indicates combinations of input controls that can be selected to enter each text character of a number of text characters. For example, the letter “i” may be entered by selecting the combination of input controls “133.” Additionally, in order to display another menu of symbols, the combination of input controls “333” may be selected. Further, the user interface 800 also indicates that an individual text character “;” is associated with the input control “4,” that the text entry operation “backspace” is associated with the input control “*,” and the text entry operation “space” is associated with the input control “0.” Although the user interface 800 shows the combination of input controls as numbers of the keypad 804, the combination of input controls could also relate to the shape of the input control (e.g. triangle, square, circle) or a function associated with an input control (e.g. play, rewind, fast forward).

In some instances, the combinations of input controls of the user interface 800 can be utilized with one or two input controls to enter text characters by associating each row of the combinations of input controls with a color. In the illustrative implementation shown in FIG. 8, the first row of the combinations of input controls is associated with the color blue, the second row is associated with the color red, and the third row is associated with the color yellow. In this way, the computing device 202 may render a plurality of user interfaces similar to the user interface 800 that include the combinations of input controls associated with each text character and also provide an option to narrow the choices of potential text characters to enter until a particular text character is entered. For example, the computing device 202 may visually and/or audibly ask a user of the computing device 202 whether the text character to be entered is associated with a blue 1. In response, the user may select an input control associated with the answer “yes” or an input control associated with the answer “no.” If the answer is “yes,” then the computing device 202 may ask whether the text character to be entered is associated with a red 1, while if the answer is “no,” then the computing device 202 may ask whether the text character to be entered is associated with a blue 2. Thus, the computing device 202 can progressively narrow the text characters to be selected based on selections of two input controls until a particular text character is selected.

In an alternative example, the combinations of input controls associated with text characters shown in the user interface 800 may be utilized with a single input control to enter text characters. In particular, rather than waiting for selection of an input control to ask a question regarding whether a text character to be entered is included in a particular group, the computing device 202 may either wait a predetermined amount of time, such as 3 or 5 seconds, before asking the question or ask the question in response to selection of a single input control. To illustrate, the computing device 202 may ask whether the text character to be entered is associated with a blue 1. If an input control is selected, then the computing device may proceed to ask whether the text character to be entered is associated with a red 1. Otherwise, after waiting the predetermined amount of time, the computing device may interpret the lack of response as “no” and then ask whether the text character to be entered is associated with a blue 2. Thus, a single input control can be utilized to narrow the choices of text characters until a particular text character is selected.

The binary and single input control entry techniques may be utilized in situations where the person entering the text has a disability or a physical impairment that limits the number of input controls that can be selected to enter text. For example, if an individual can communicate by moving a single finger or by blinking, text can be entered based on movement of the single finger or by blinking In the case of blinking, the input control may include a camera or other optical device that recognizes when a person blinks and provides a corresponding indication when a blink occurs.

In another implementation, the combinations of input controls to enter text characters shown in the user interface 800 may be reproduced on a printed medium. In this way, rather than a computing device asking whether a text character is associated with a particular input control/color combination (i.e. a blue 1), another person may ask the question and provide an input to a computing device based on the individual's response, such as a blink or finger movement.

FIGS. 9-10 show processes 900 and 1000, respectively, to enter text. The processes 900 and 1000 are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement a particular process.

FIG. 9 is a flow diagram illustrating a first implementation of a process 900 to enter text characters. At 902, a number of text characters are identified. In a particular example, the number of text characters may be lowercase or uppercase letters of an Alphabet, such as the English Alphabet. In other examples, the number of text characters may be characters of a different alphabet, such as the Chinese Alphabet or the Greek Alphabet, or punctuation symbols. The number of text characters may be associated with a particular set of text characters, a group of text characters, or a sub-group of text characters. Additionally, the number of text characters may be associated with a portion of a set of text characters. To illustrate, a set of text characters may be large, such as the number of text characters of the Chinese Alphabet, and the set of text characters may be divided into a plurality of portions.

At 904, the number of text characters is divided into a plurality of groups or sub-groups. The groups may include an equal number of text characters or different numbers of text characters. In addition, the number of groups may be based on a number of input controls to be utilized to enter text. For example, when three input controls are utilized to enter text, the number of text characters may be divided into three groups, three sub-groups, and/or three additional sub-groups.

At 906, at least one input control is assigned to each group or sub-group. In some instances, a single button of a keypad may be assigned to a particular group. In other instances, a row or column of buttons of a keypad may be assigned to a particular group. The assignment of the input control to the particular group may be predetermined, dynamically assigned, or based on user input.

At 908, a selection of an input control is received. For example, an input control may be selected by pressing a button of a keypad or gaming controller or touching a virtual button of a touch screen.

At 910, if the input control selected is associated with a particular text character, then the process 900 proceeds to 912, where the particular text character is entered. An input control may be associated with a particular text character when one or more groups or sub-groups of a set of text characters have been previously divided or sub-divided such that an input control is currently associated with a single text character. Additionally, an input control may be associated with a particular text character based on a user customization input, as part of a default assignment of input controls, or based on frequency of use of the particular text character. Alternatively, when the input control selected is not associated with a particular text character, that is, the selected input control is associated with a particular group or sub-group, then the process 900 returns to 902 where the selected group or sub-group is further divided and input controls are associated with the sub-groups or additional sub-groups until a particular text character is selected. After entry of a text character at 912, the process 900 may return to 902 to begin selection of another text character.

FIG. 10 is a flow diagram illustrating a second implementation of a process 1000 to enter text characters. At 1002, a first input control is assigned to a particular group of text characters. For example, an input control, such as a button of a keypad, may be assigned to a group of English alphabet characters or punctuation symbols. The particular group of text characters may be one of a number of groups of text characters associated with respective input controls.

At 1004, a second input control is assigned to at least one particular text character based on user input. In an illustrative implementation, a user of a computing device may customize settings for text entry by associating a certain input control with a favorite text character or a favorite group of text characters.

In addition, at 1006 one or more text characters may be predicted to be entered. The predicted text characters may be based on characters previously entered in a message being composed, such as characters associated with likely words that are being entered. At 1008, a third input control is dynamically assigned to the predicted text characters to be entered. In some implementations, the input controls assigned to predicted text characters may be selected from a set of input controls that has not already been assigned to a particular group of text characters or to user selected text characters.

At 1010, a fourth input control is assigned to an additional text character based on frequency of use of the additional text character. For example, an input control that has not been previously assigned to another text character or group of text characters may be automatically assigned to frequently used text characters, such as certain vowels of the English Alphabet, certain punctuation symbols, or groups of punctuation symbols, such as “;).”

At 1012, a user interface is rendered that indicates the association between the first, second, third, and fourth input controls and the text characters or groups of text characters associated with the respective input controls. In some cases, the first, second, third, and fourth input controls may be buttons of a telephone keypad. In other scenarios, the first, second, third, and fourth input controls may be input controls of a gaming controller, such as a bumper button, a trigger, a face button, or a combination thereof. Examples of user interfaces that include input controls associated with various text characters and groups of text characters are shown in FIGS. 3-8.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
identifying a number of text characters by a computing device including a processor executing a text entry module;
dividing, by the computing device, the number of text characters into a first plurality of groups;
assigning, by the computing device, an input control to each group of the first plurality of groups;
displaying, by the computing device, a first user interface including the first plurality of groups and the input control assigned to each group of the first plurality of groups;
receiving, by the computing device, a selection of a particular group of the first plurality of groups via the input control corresponding to the particular group;
dividing, by the computing device, text characters of the particular group into a second plurality of groups;
assigning one of the input controls to each group of the second plurality of groups; and
displaying, by the computing device, a second user interface including the second plurality of groups and the input control assigned to each group of the second plurality of groups.

2. The method of claim 1, wherein each group of the second plurality of groups comprises a single text character.

3. The method of claim 2, further comprising:
receiving, by the computing device, a selection of a particular group of the second plurality of groups via the input control corresponding to the particular group of the second plurality of groups; and
displaying, by the computing device, the single text character of the particular group of the second plurality of groups.

4. The method of claim 1, wherein each group of the second plurality of groups comprises a plurality of text characters.

5. The method of claim 4, further comprising:
receiving, by the computing device, a selection of a particular group of the second plurality of groups via the input control corresponding to the particular group of the second plurality of groups;
dividing, by the computing device, text characters of the particular group of the second plurality of groups into a third plurality of groups, each group of the third plurality of groups comprising a single text character;
assigning one of the input controls to each group of the third plurality of groups; and
displaying, by the computing device, a third user interface including the third plurality of groups and the input control assigned to each group of the third plurality of groups.

6. The method of claim 5, further comprising:
receiving, by the computing device, a selection of a particular group of the third plurality of groups via the input control corresponding to the particular group of the third plurality of groups; and
displaying, by the computing device, the single text character of the particular group of the third plurality of groups.

7. The method of claim 1, further comprising:
assigning, by the computing device, an additional input control to a first respective text character, the first user interface including the first respective text character associated with the additional input control;
receiving, by the computing device, a selection of the first respective text character via the additional input control; and
displaying, by the computing device, the first respective text character.

8. The method of claim 7, further comprising assigning, by the computing device, the additional input control to a second respective text character in response to selection of the first respective text character, the second user interface including the second respective text character associated with the additional input control.

9. An apparatus comprising:
a processor;
memory accessible to the processor, the memory storing:
a character grouping module executable by the processor to create a plurality of groups from a number of text characters and to create a plurality of sub-groups from the text characters of each group of the plurality of groups; and
an input control assignment module executable by the processor to assign a predetermined input control to each group of the plurality of groups and to assign an additional input control to a respective text character of a particular group in response to selection of the predetermined input control assigned to the particular group.

10. The apparatus of claim 9, further comprising a text entry user interface module executable by the processor to render a user interface indicating the predetermined input control assigned to each group of the plurality of groups of the text characters.

11. The apparatus of claim 10, wherein the user interface indicates the additional input control assigned to the respective text character.

12. The apparatus of claim 10, wherein the user interface includes a text entry portion indicating text characters entered via selection of one or more input controls.

13. The apparatus of claim 9, further comprising a text entry user interface module executable by the processor to render a user interface indicating a respective combination of input controls to enter each text character of the number of text characters.

14. The apparatus of claim 9, further comprising a text entry user interface module executable by the processor to render a user interface including a default assignment of input controls.

15. The apparatus of claim 9, wherein the input control assignment module is executable by the processor to assign a particular input control to one or more additional sets of characters.

16. The apparatus of claim 9, further comprising an input device including one or more input controls.

17. The apparatus of claim 9, further comprising at least one of a wireless communication interface and a wireline communication interface to receive data from an input device indicating selection of a particular input control.

18. One or more computer-readable storage media including instructions that, when executed by a processor, perform operations comprising:
assigning a first input control to a particular group of text characters of a plurality of groups of text characters;
assigning a second input control to a particular text character based at least in part on user input; and
displaying a user interface including the plurality of groups of text characters, the user interface indicating that the first input control corresponds to the particular group of text characters and that the second input control corresponds to the particular text character.

19. The one or more computer-readable storage media of claim 18, wherein the operations further comprise:
predicting one or more text characters to be entered; and
dynamically assigning a third input control to a text character that is predicted to be entered.

20. The one or more computer-readable storage media of claim 19, wherein the operations further comprise automatically assigning a fourth input control to an additional text character based at least in part on frequency of use of the additional text character.
